(19) United States
(12) Patent Application Publication
(10) Pub. No.: US 2005/0020205 A1
(43) Pub. Date: Jan. 27, 2005

(54) Apparatus and method for carrier feedthrough cancellation in RF upconverters

(76) Inventor: Ramin Khoini-Poorfard, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/626,062

(22) Filed: Jul. 23, 2003

(51) Int. Cl. H04B 7/165

(52) U.S. Cl. 455/23

(57) ABSTRACT

An RF upconverter (400, 500) includes an upconverter core (100), an electrical measurement circuit, and a summing device (406). The upconverter core (100) has an input terminal for receiving a first signal having predetermined spectral content at an input frequency and an output terminal for providing an output signal having substantially the predetermined spectral content at a higher frequency using a local oscillator signal having a carrier frequency. The electrical measurement circuit has an input terminal coupled to the output terminal of the upconverter core (100), and an output terminal for providing a first offset correction signal representative of a power of the output signal at the carrier frequency. The summing device (406) has a positive input terminal for receiving a first input signal, a negative input terminal coupled to the output terminal of the electrical measurement circuit, and an output terminal coupled to the input terminal of the upconverter core (100) for providing the first signal.

### CROSS-REFERENCE TO RELATED APPLICATION

Related subject matter is found in my copending U.S. patent application Ser. No. ______, entitled “Communication Terminal with Low Carrier Feedthrough and Communication System Using Such a Terminal”, filed of even date herewith and assigned to the assignee hereof.

### TECHNICAL FIELD

The present invention generally relates to radio frequency (RF) transmitters, and more particularly to upconverters for use in RF transmitters.

### BACKGROUND

Radio frequency (RF) devices transmit an information signal from one point to another by moving the information signal to a higher frequency range that is more suitable for transmission over the medium being used. This process is known as upconversion. As used herein, “radio frequency signal” means an electrical signal conveying useful information and having a frequency from about 3 kilohertz (kHz) to thousands of gigahertz (GHz), regardless of the medium through which such signal is conveyed. Thus an RF signal may be transmitted through air, free space, coaxial cable, fiber optic cable, etc. An RF transmitter mixes the desired signal, known as the baseband signal, with an RF carrier frequency for transmission over the selected medium. An RF receiver then mixes the signal with the carrier frequency to restore the signal to its original frequency.

An upconverter is a circuit used in RF transmitters to move an information spectrum from a first frequency to a second, higher frequency, such as from baseband to RF. In an ideal upconverter, the information spectrum is perfectly reproduced at the higher frequency. However a practical upconverter, made using non-ideal circuit components, inserts additional power at the carrier frequency. This condition is known as carrier feedthrough.

In some applications, carrier feedthrough is highly undesirable. For example, satellite modulator-demodulators (modems) use time division multiplexing for bidirectional communication between a satellite and a large number of terrestrial stations. Unwanted power caused by carrier feedthrough in the terrestrial stations accumulates and interferes with the wanted signal of an adjacent channel. Thus in such systems carrier feedthrough requirements on each modem are very strict.

However known carrier feedthrough suppression techniques have drawbacks. One known technique uses manual calibration. To accommodate a large range of tuning frequencies the calibration must be performed for a carrier frequency in the middle of the band of interest. This type of calibration results in inadequate carrier frequency suppression when the desired channel is near the high end or the low end of the frequency range.

It is also possible to suppress carrier feedthrough by using a high-quality notch filter having a notch at the carrier frequency. However this notch filter requires precision components and is difficult to achieve when the tuning frequency changes. It is expensive to implement since it requires discrete elements to achieve the needed precision, adding to system cost. The notch filter also distorts the desired signal spectrum.

Accordingly, it would be desirable to have an RF upconverter with high carrier frequency suppression without the need for manual calibration or expensive filters. These and other desirable features and characteristics of the present invention will become apparent from the subsequent detailed description and the appended claims, taken in conjunction with the accompanying drawings and the foregoing technical field and background.

### BRIEF SUMMARY

A radio frequency (RF) upconverter with carrier feedthrough cancellation is provided that includes an upconverter core, an electrical measurement circuit, and a first summing device. The upconverter core has a first input terminal for receiving a first signal having predetermined spectral content at an input frequency and an output terminal for providing an output signal having substantially the predetermined spectral content at a higher frequency using a local oscillator signal having a carrier frequency. The electrical measurement circuit has an input terminal coupled to the output terminal of the upconverter core, and a first output terminal for providing a first offset correction signal representative of a power of the output signal at the carrier frequency. The first summing device has a positive input terminal for receiving a first input signal, a negative input terminal coupled to the first output terminal of the electrical measurement circuit, and an output terminal coupled to the first input terminal of the upconverter core for providing the first signal.

A method is also provided for carrier feedthrough cancellation in an RF upconverter. A first signal having predetermined spectral content is converted from an input frequency to a higher frequency using a local oscillator signal having a carrier frequency and an output signal is provided having substantially the predetermined spectral content in response thereto. A power of the output signal at the carrier frequency is electrically measured and a first offset correction signal is provided in response thereto. The first offset correction signal is subtracted from a first input signal to provide the first signal.

### BRIEF DESCRIPTION OF THE DRAWINGS

The present invention will hereinafter be described in conjunction with the following drawing figures, wherein like numerals denote like elements, and

FIG. 1 illustrates in partial block diagram and partial schematic form an upconverter known in the prior art;

FIG. 2 illustrates a frequency domain graph of the carrier feedthrough rejection of the upconverter of FIG. 1;

FIG. 3 illustrates in partial block diagram and partial schematic form an upconverter with carrier feedthrough rejection known in the prior art;

FIG. 4 illustrates in partial block diagram and partial schematic form an upconverter for use in a radio frequency (RF) transmitter according to the present invention;

FIG. 5 illustrates in partial block diagram and partial schematic form a modification to the upconverter of FIG. 4 according to another aspect of the present invention;

FIG. 6 illustrates a flow chart of the calibration procedure used in conjunction with the upconverter of FIG. 5;

FIG. 7 illustrates a satellite communication system using the RF upconverter of either FIG. 4 or FIG. 5 according to the present invention; and

FIG. 8 illustrates a cellular telephone communication system using the RF upconverter of either FIG. 4 or FIG. 5 according to the present invention.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

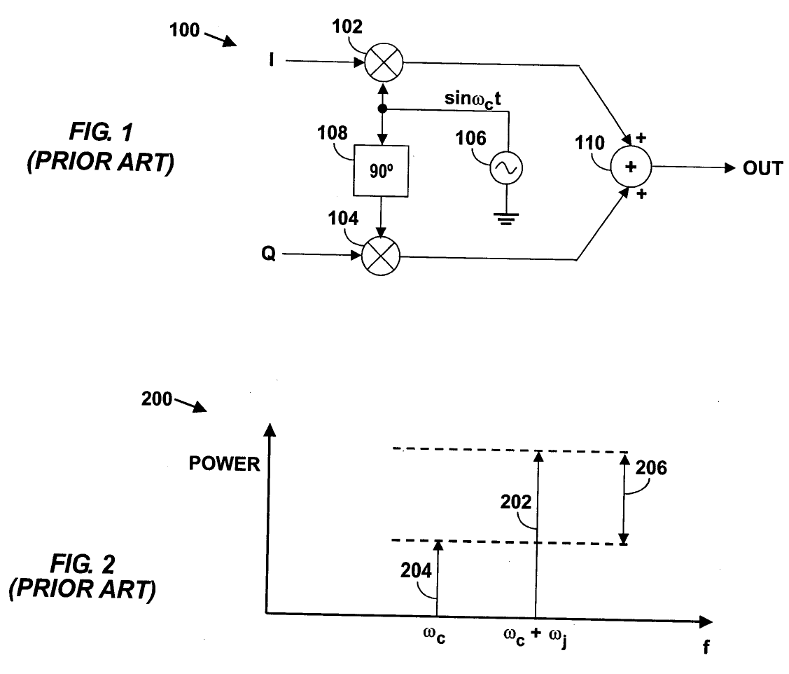

FIG. 1 illustrates in partial block diagram and partial schematic form an upconverter 100 known in the prior art. Upconverter 100 includes generally a mixer 102, a a mixer 104, an oscillator 106, a phase shifter 108, and a summing device 110. Mixer 102 has a first input terminal for receiving an in-phase (I) signal, a second input terminal, and an output terminal. Mixer 104 has a first input terminal for receiving a quadrature (Q) signal, a second input terminal, and an output terminal. Oscillator 106 has an output terminal connected to the second input terminal of mixer 102 for providing a local oscillator signal labeled “sin ω_{c}t” referenced to a ground terminal. Phase shifter 108 has an input terminal connected to the output terminal of oscillator 106, and an output terminal connected to the second input terminal of mixer 104. Summing device 110 has a first positive input terminal connected to the output terminal of mixer 102, a second positive input terminal connected to the output terminal of mixer 104, and an output terminal for providing an output signal labeled “OUT”.

Upconverter 100 receives a complex baseband input signal having in-phase and quadrature components, and combines and mixes them to a higher frequency such as a suitable radio frequency (RF) for transmission. Thereby upconverter 100 substantially reproduces the original spectral content at the higher frequency. The transmission may take the form of, for example, radiation through an antenna. In the ideal case, the OUT signal is derived as:
OUT=I sin ω_{c}t+Q cos ω_{c}t [1]
The technique disclosed herein is applicable to almost any type of underlying modulation scheme having various spectral contents including amplitude modulation (AM), phase modulation (PM), frequency modulation (FM), quadrature amplitude modulation (QAM), pulse code modulation (PCM), phase shift keying (PSK), etc. For example, in a typical continuous PM system such as that used in a satellite modem, I=cos φ(t) and Q=sin φ(t), which yields:
OUT=cos φ(t)sin ω_{c}t+sin φ(t)cos φ_{c}t [2]
If φ(t)=ωⱼt, where ωⱼ is a constant frequency, then
OUT=sin(ω_{c}+ωⱼ)t [3]
Thus in the ideal case, OUT has power in the frequency domain only at (ω_{c}+ωⱼ). However in a practical implementation, imperfections in components work to alter the frequency content. One source of imperfection is the zero frequency (DC) offsets in the I and Q branches. This imperfection could be caused by DC offsets in digital-to-analog converters (DACs) that generate the I and Q signals, or by input-referred offsets in the mixers.

The result of these DC offsets is that the OUT signal includes significant power at the carrier frequency. This effect is better understood with respect to FIG. 2, which illustrates a frequency domain graph 200 of the carrier feedthrough rejection of upconverter 100 of FIG. 1. In FIG. 2 the horizontal axis represents frequency and the vertical axis represents power. From FIG. 2 it is seen that the power spectrum of OUT includes power 202 at the desired frequency of (ω_{c}+ωⱼ), but also power 204 at the carrier frequency ω_{c}. Thus as shown the carrier feedthrough rejection is equal to a difference in power 206 between the desired power 202 at (ω_{c}+ωⱼ) and the carrier frequency power 204 at ω_{c}.

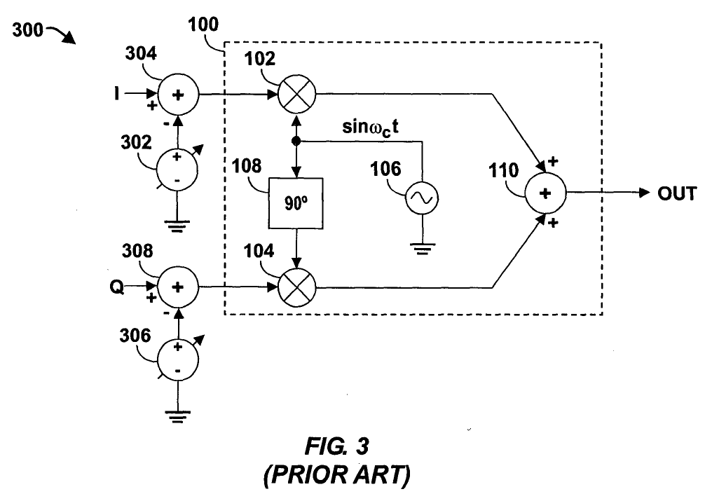

It is desirable to reduce the carrier feedthrough and FIG. 3 illustrates in partial block diagram and partial schematic form an upconverter 300 with carrier feedthrough rejection known in the prior art. Upconverter 300 includes generally upconverter core 100 as described with respect to FIG. 1, a variable voltage source 302, a summing device 304, a variable voltage source 306, and a summing device 308. Variable voltage source 302 provides a DC voltage to an output terminal thereof in response to a tuning input. Summing device 304 has a positive input terminal for receiving signal I, a negative input terminal connected to the output terminal of variable voltage source 302, and an output terminal connected to the input terminal of mixer 102 in upconverter core 100. Variable voltage source 306 provides another DC voltage to an output terminal thereof in response to a tuning input. Summing device 308 has a positive input terminal for receiving signal Q, a negative input terminal connected to the output terminal of variable voltage source 306, and an output terminal connected to the input terminal of mixer 104 in upconverter core 100.

Upconverter 300 includes variable voltage sources 302 and 306 to improve carrier feedthrough rejection. These voltage sources equalize DC offsets in the I and Q branches by adding DC components that approximately offset carrier power 204. A known method of setting the values of voltage sources 302 and 306 is to measure the power of OUT at ω_{c} using a spectrum analyzer, and manually adjust the tuning inputs of voltage sources 302 and 306 until the power at ω_{c} is approximately zero.

However this procedure is only partially effective. Power can also directly couple (magnetically or capacitively) from the inputs of mixers 102 and 104 into their respective outputs, and the level of coupling is frequency dependent. Therefore the magnitude of carrier feedthrough rejection 206 is a function of frequency. However voltage sources 302 and 306 are usually tuned to minimize DC offsets using a carrier frequency near the center of the band of interest and as the carrier frequency varies from the center frequency, the power in the OUT signal at the carrier frequency will become significant.

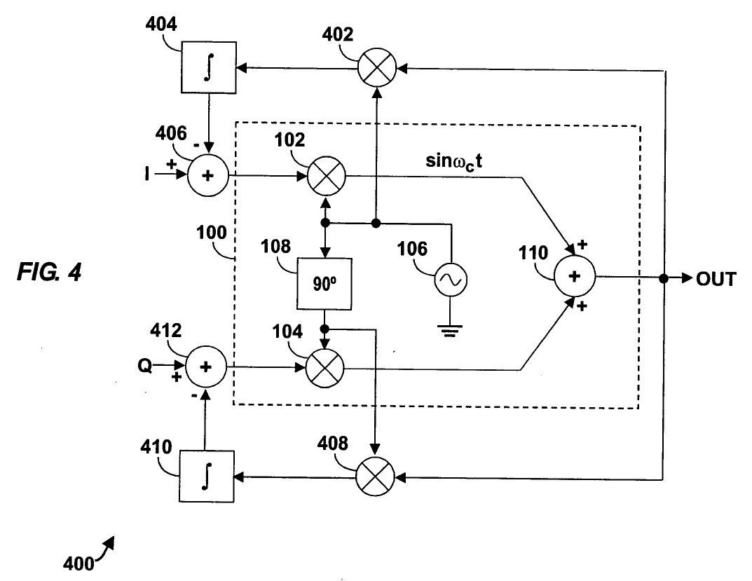

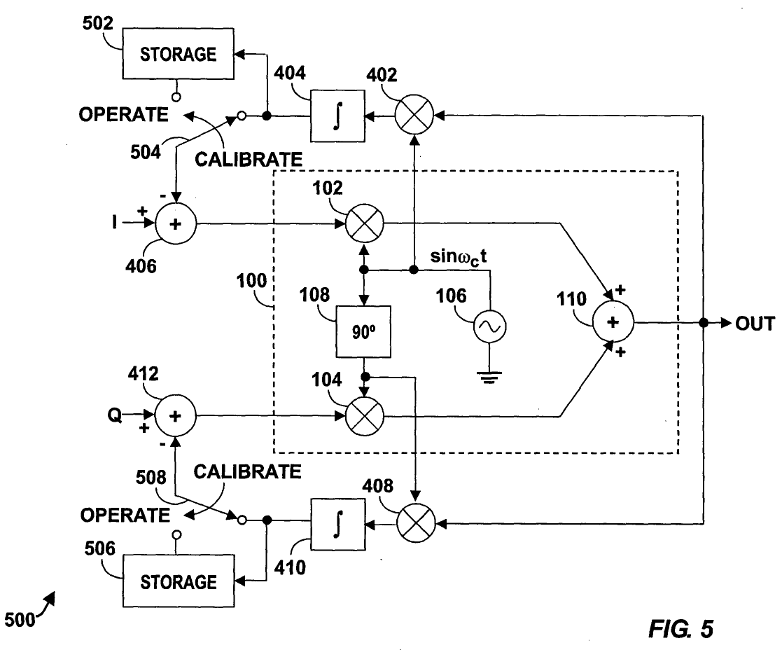

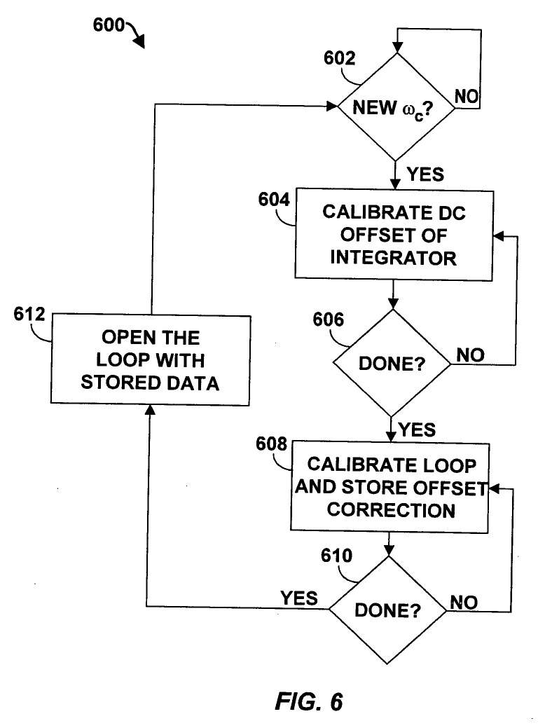

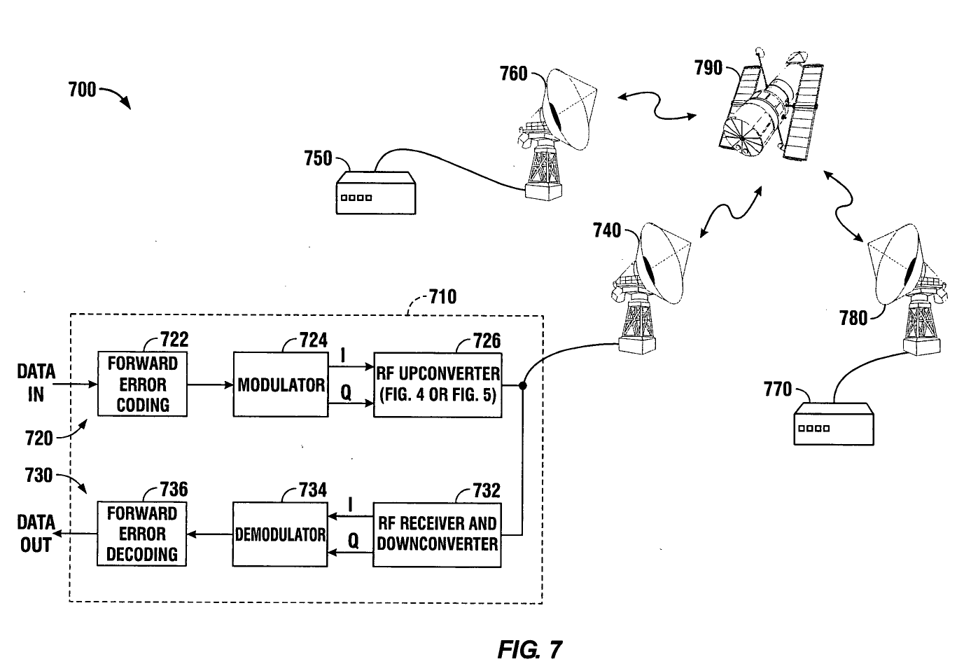

FIG. 4 illustrates in partial block diagram and partial schematic form an upconverter 400 for use in a radio frequency (RF) transmitter according to the present invention. Upconverter 400 includes generally upconverter core 100, a mixer 402, an integrator 404, a summing device 406, a mixer 408, an integrator 410, and a summing device 412. Upconverter core 100 is constructed as shown in FIG. 1. Mixer 402 has a first input terminal for receiving the OUT signal, a second input terminal connected to the output terminal of oscillator 106, and an output terminal. Integrator 404 has an input terminal connected to the output terminal of mixer 402, and an output terminal. Summing device 406 has a positive input terminal for receiving the I signal, a negative input terminal connected to the output terminal of integrator 404, and an output terminal connected to the first input terminal of upconverter core 100. Mixer 408 has a first input terminal for receiving the OUT signal, a second input terminal connected to the output terminal of phase shifter 108, and an output terminal. Integrator 410 has an input terminal connected to the output terminal of mixer 408, and an output terminal. Summing device 412 has a positive input terminal for receiving the Q signal, a negative input terminal connected to the output terminal of integrator 410, and an output terminal connected to the second input terminal of upconverter core 100.

In operation, upconverter 400 electrically measures the level of carrier feedthrough in the I and Q signal paths that are reflected in the OUT signal and subtracts the measured levels from their corresponding input signals. The measurement takes place as follows. Mixers 402 and 408 mix the OUT signal using the corresponding local oscillator signals, namely the output of oscillator 106 for the I path and the output of phase shifter 108 for the Q path. The outputs of mixers 402 and 408 contain significant power at DC corresponding to the carrier power as well as power at higher frequencies. Integrators (also known as lowpass filters) 404 and 410 filter out the higher frequency components, leaving only the DC components corresponding to the carrier feedthrough power. These DC components become correction signals in the I and Q paths. Although changing the local oscillator frequency changes the carrier feedthrough, mixer 400 tracks the new level and automatically changes the correction signals provided to the inputs of summing devices 406 and 412. This automatic correction also adapts for temperature variations.

However some of the real signal spectrum around DC will be nullified due to the measurement process. This nullification effect shows up as a narrow notch in the frequency spectrum near the carrier frequency. To reduce this effect, the integrator cutoff frequency fν should be as low as possible compared to the bit rate. Typically the integrator fν is set to 0.01% of the bit rate.

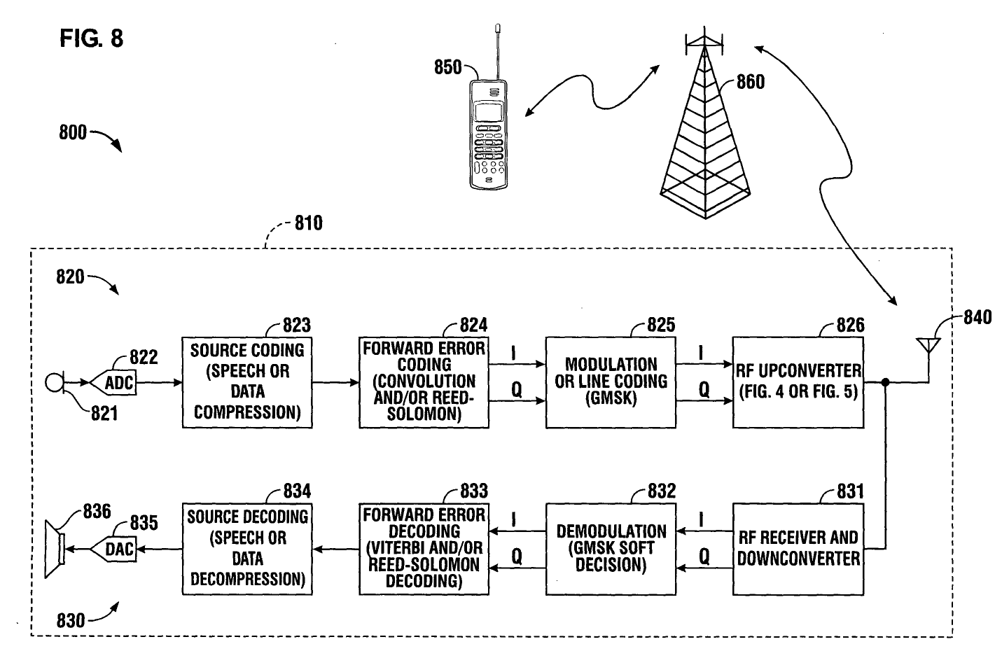

A method to eliminate the notch is shown in FIG. 5, which illustrates in partial block diagram and partial schematic form an upconverter 500 according to another aspect of the present invention. Upconverter 500 includes upconverter core 100, mixer 402, integrator 404, summing device 406, mixer 408, integrator 410, and summing device 412 connected substantially as shown in FIG. 4. In addition, upconverter 500 includes a storage element 502, a switch 504, a storage element 506, and a switch 508. Storage element 502 has an input terminal connected to the output terminal of integrator 404, and an output terminal. Switch 504 has a first terminal connected to the negative input terminal of summing device 406, and a second terminal alternately connected to the second terminal of integrator 504 during a CALIBRATE period and to the output terminal of storage element 502 during an OPERATE period. Storage element 506 has an input terminal connected to the output terminal of integrator 410, and an output terminal. Switch 508 has a first terminal connected to the negative input terminal of summing device 412, and a second terminal alternately connected to the second terminal of integrator 410 during the CALIBRATE period and to the output terminal of storage element 506 during the OPERATE period.

In operation the second terminals of switches 504 and 508 are connected to the outputs of integrators 404 and 410, respectively, during the CALIBRATE period and to the outputs of storage elements 502 and 506, respectively, during the OPERATE period. During the CALIBRATE period the loops are closed and upconverter 500 uses the measurement and feedback technique described with reference to FIG. 4 above to cancel the DC offsets. After integrators 404 and 410 have settled for a particular ω_{c}, however, the outputs thereof are stored in storage elements 502 and 506, respectively, and the loops are opened. By calibrating the loop every time that the channel is changed and storing the offset correction signal, either digitally or through analog capacitors, and then opening the loop for the OPERATE period, upconverter 500 eliminates the notch from appearing in the middle of the RF frequency spectrum.

The calibration process can be better understood with reference to FIG. 6, which illustrates a flow chart 600 of the calibration procedure used in conjunction with upconverter 500 of FIG. 5. The flow begins at decision box 602, which waits until the carrier frequency ω_{c} changes. After a change in ω_{c}, at step 604, the DC offset of the integrator itself is first calibrated by any of a number of techniques well known in the art. This process occurs until at step 606 it is determined that the settling time of the integrator has been reached. Then at step 608 the DC offset of the loop is calibrated and stored in storage elements 502 and 506. Step 610 causes step 608 to be repeated until the integrators have settled, and then directs the flow to box 612 which opens the loop using the stored data. The loop so configured operates until at step 602 the carrier frequency ω_{c} is again changed.

It should be noted that while carrier frequency rejection was illustrated in the context of a baseband-to-RF converter, it would be equally applicable to an intermediate frequency (IF) to RF converter to prevent carrier signal power from being transmitted. Furthermore various elements such as summing devices and integrators were illustrated generically but could be implemented in either the analog domain or the digital domain as would be appreciated by those in the art. In one typical example, the outputs of the feedback mixers (after some anti-aliasing filtering) can be digitized by analog-to-digital (A/D) converters and then filtered by digital integrators (or moving average filters). The output of the digital integrators (or filters) can then be stored in memories or registers, while being applied as the offset correction signals to summing devices through digital-to-analog (D/A) converters. Alternatively, one can use a successive approximation or a binary search algorithm with such hardware. In this scheme, the digital integrator (filter) output will be compared to a prior value in a comparator and the result of the comparison will be input to a state machine, which in turn will iteratively estimate the proper digital code for the D/A converters such that iteratively, the digital integrator (filter) output becomes smaller and smaller.

The carrier frequency rejection technique described herein is applicable to an upconverter for any arbitrary communication system in which it is desired to suppress carrier frequency power. A communication system using the technique described herein in one or more of the stations will need higher signal-to-noise ratio (SNR) for a wanted signal and hence higher quality signal transmission. One example of a communication system to which this technique is especially useful is a TDMA satellite communication system. FIG. 7 illustrates such a satellite communication system 700 using the RF upconverter of either FIG. 4 or FIG. 5 according to the present invention. System 700 includes generally a satellite modem 710, an antenna 740, a satellite modem 750, an antenna 760, a satellite modem 770, an antenna 780, and an orbital satellite 790.

Satellite modem 710 is a terrestrial terminal in the form of a transceiver that sends data to satellite 790 and receives data from satellite 790. As used herein, “communication terminal” means a device that forms a terminating part or end of a communication link or channel, regardless of whether the signal is retransmitted or relayed. Furthermore the communication terminal may transmit to only one station in the case of a point-to-point system, or to multiple stations. Satellite modem 710 includes a transmit path 720 and a receive path 730. Transmit path 720 includes generally a forward error coding block 722, a modulator 724, and an RF upconverter 726. Forward error coding block 722 has an input terminal for receiving a data signal labeled “DATA IN”, and an output terminal. Forward error coding block 722 adds redundancy to the data stream to allow system 700 to recover from events such as noise bursts without loss of data. There are several types of forward error coding, including block coding, convolutional coding, and trellis coding, which may be used alone or in combination to produce the desired signal-to-noise ratio (SNR) at the receiver for the channel's bit error ratio.

Modulator 724 has an input terminal connected to the output terminal of forward error coding block 722, and output terminals for providing an in-phase signal I and a quadrature signal Q to the corresponding input terminals of RF upconverter 726. In general modulator 724 can apply any known type of modulation scheme, including AM, PM, FM, QAM, PCM, PSK, etc.

RF upconverter 726 has input terminals connected to the I and Q output terminals of modulator 726, and an output terminal connected to an antenna 740 for transmission through the atmosphere to satellite 790. RF upconverter 726 could be implemented by either upconverter 400 of FIG. 4 or upconverter 500 of FIG. 5 depending on the considerations discussed above.

Receive path 730 includes performs the reverse process as transmit path 720 and includes corresponding blocks to those in transmit path 720, including an RF receiver and downconverter 732, a line decoder 734, and a channel decoder 736. RF receiver and downconverter 732 has an input terminal connected to antenna 740, and I and Q output terminals. RF receiver and downconverter 732 converts the received RF signal to a baseband signal formed by signals I and Q. Many suitable RF receiver architectures are known to those in the art, including a direct downconverter and a downconverter that first converts the received signal to IF for further filtering before converting the IF signal to baseband. Demodulator 734 has input terminal connected to the I and Q output terminals of RF receiver and downconverter 732, and an output terminal. Demodulator 734 performs the reverse modulation process as modulator 724. Forward error decoding block 736 has an input terminal connected to the output terminal of demodulator 734, and an output terminal for providing an output signal of modem 710 labeled “DATA OUT”. Forward error decoding block 736 performs the reverse process as forward error coding block 722. For example if convolutional coding was used, forward error decoding block 736 performs decoding using the Viterbi algorithm to decode the symbols encoded on the I and Q signals into a stream of data bits.

Additional elements such as antenna diplexers, RF power amplifiers, RF filters, etc. will be present in an actual implementation. However their functions are well understood in the radio art and they have been omitted from FIG. 7.

Satellite 790 serves as the hub of satellite communication system 700. In two-way satellite communication systems, several modems may transmit on the same frequency though at different times. However during non-transmission periods, each modem may allow its local oscillator to continue operating because the settling time would be too long. Thus while a given station is transmitting, the other modems operating on the channel in a TDM fashion would still emanate energy at the local oscillator frequency due to their carrier feedthrough power which degrades the overall signal received by a satellite receiver. Modem 710 reduces this unwanted power due to its high carrier feedthrough suppression.

As another example, FIG. 8 illustrates a cellular telephone communication system 800 using the RF upconverter of either FIG. 4 or FIG. 5 according to the present invention. System 800 implements the Global System for Mobile Communication (GSM) system using TDMA techniques. System 800 includes generally a GSM handset 810 forming a communication terminal which, in conjunction with other handsets such as a handset 850, communicates with a cellular base station serving as a hub of the cell through a cellular antenna 860 for call placement and reception. GSM handset 810 includes a transmit path 820 and a receive path 830, and an antenna 840. Transmit path 820 includes a microphone 821, an analog-to-digital converter (ADC) 822, a source coding block 823, a forward error coding block 824, a modulation or line coding block 825, and an RF upconverter 826. Microphone 821 is physically situated in GSM handset 810 to receive human speech and to transduce the speech into a corresponding electrical signal at an output thereof. ADC 822 has an input terminal connected to the output terminal of microphone 821, and an output terminal.

Source coding block 823 has an input terminal connected to the output terminal of DAC 822, and an output terminal. In GSM, source coding block 823 includes several processes that assist error recovery, including speech coding and data compression.

Forward error coding block 824 has an input terminal connected to the output terminal of forward error coding block 823, and I and Q output terminals. Forward error coding block 824 performs block coding, convolutional and/or Reed-Solomon coding, bit and block interleaving, and packet formation.

Modulation or line coding block 825 has I and Q input terminal connected to the corresponding I and Q output terminals of modulator 824, and I and Q output terminals. For use in GSM, modulation or line coding block 825 uses Gaussian minimum shift keying (GMSK) as the modulation scheme.

RF upconverter 826 has input terminals connected to the I and Q output terminals of line coder 825, and an output terminal connected to antenna 840 for transmission through the atmosphere to cellular base station antenna 860. RF upconverter 826 could be implemented by either upconverter 400 of FIG. 4 or upconverter 500 of FIG. 5 depending on the considerations discussed above.

Receive path 830 includes an RF receiver and downconverter 831, a demodulation block 832, a forward error decoding block 833, a source decoding block 834, a digital-to-analog converter (DAC) 835, and a loudspeaker 836. RF receiver and downconverter 831 has an input terminal connected to antenna 840, and output terminals for providing I and Q signals at baseband. RF receiver and downconverter 831 converts the received RF signal to a baseband signal formed by signals I and Q, and as in satellite modem 710 may use a suitable RF receiver architecture known in the art

Demodulation block 832 has input terminals connected to the I and Q output terminals of RF receiver and downconverter 831, and I and Q output terminals. Demodulation block 832 performs GMSK demodulation using a soft decision process.

Forward error decoding block 833 has input terminals connected to the I and Q output terminals of demodulation block 832, and an output terminal. Forward error decoding block 833 uses Reed-Solomon decoding and/or the well known Viterbi algorithm to determine the most likely data to provide to its output.

Source decoding block 834 has an input terminal connected to the output terminal of forward error decoding block 833, and an output terminal. Source decoding block 834 performs the reverse process of block 823, including speech or data decompression.

DAC 835 has an input terminal connected to the output terminal of source decoding block 834, and an output terminal connected to an input terminal of loudspeaker 836. Loudspeaker 836 transduces the electrical output signal of DAC 835 to provide an audible sound.

Additional elements such as antenna diplexers, RF power amplifiers, RF filters, etc. will be present in an actual implementation. However their functions are well understood in the radio art and they have been omitted from FIG. 8.

Like the satellite modem system 700 illustrated in FIG. 7, the accumulation of unwanted power caused by carrier feedthrough is also highly undesirable in the GSM cellular telephone system. Thus the use of GSM handsets having low carrier feedthrough will increase the SNR in the wanted signal received at the base station and improve system quality.

Satellite modem and GSM systems are also only examples of systems which could benefit according to the carrier feedthrough suppression technique discussed herein. This technique is useful in any RF communication system that needs to have or benefits from low carrier feedthrough characteristics. While the systems illustrated in FIGS. 7 and 8 were full duplex, it should be apparent that the low carrier feedthrough technique is applicable to half-duplex terminals that only include transmitters.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A radio frequency (RF) upconverter with carrier feedthrough cancellation comprising:
an upconverter core having a first input terminal for receiving a first signal having predetermined spectral content at an input frequency and an output terminal for providing an output signal having substantially said predetermined spectral content at a higher frequency using a local oscillator signal having a carrier frequency;
an electrical measurement circuit having an input terminal coupled to said output terminal of said upconverter core, and a first output terminal for providing a first offset correction signal representative of a power of said output signal at said carrier frequency; and
a first summing device having a positive input terminal for receiving a first input signal, a negative input terminal coupled to said first output terminal of said electrical measurement circuit, and an output terminal coupled to said first input terminal of said upconverter core for providing said first signal.

2. The RF upconverter of claim 1 wherein said electrical measurement circuit comprises:
a first mixer having a first input terminal for receiving said output signal, a second input terminal for receiving said local oscillator signal, and an output terminal; and
a first integrator having an input terminal coupled to said output terminal of said first mixer, and an output terminal for providing said first offset correction signal.

3. The RF upconverter of claim 2 wherein said electrical measurement circuit further comprises:
a storage element having an input terminal coupled to said output terminal of said integrator, and an output terminal; and
a switch having a first terminal for providing said first output terminal of said electrical measurement circuit, and a second terminal alternately coupled to said output terminal of said first integrator during a calibrate period and to said output terminal of said storage element during an operate period.

4. The RF upconverter of claim 1 wherein said upconverter core further has a second input terminal for receiving a second signal characterized as being in quadrature with said first signal and further provides said output signal by converting said second signal to said higher frequency using a quadrature local oscillator signal having said carrier frequency.

5. The RF upconverter of claim 4 wherein said upconverter core comprises:
a first mixer having a first input terminal for receiving said first signal, a second input terminal for receiving said local oscillator signal, and an output terminal;
a second mixer having a first input terminal for receiving said second signal, a second input terminal for receiving said quadrature local oscillator signal, and an output terminal;
a phase shifter having an input terminal for receiving said local oscillator signal, and an output terminal coupled to said second input terminal of said second mixer for providing said quadrature local oscillator signal; and
a summing device having a first positive input terminal coupled to said output terminal of said first mixer, a second positive input terminal coupled to said output terminal of said second mixer, and an output terminal for providing said output signal.

6. The RF upconverter of claim 4 wherein said electrical measurement circuit further has a second output terminal for providing a second offset correction signal representative of a power of said output signal at said carrier frequency and in quadrature with said first offset correction signal, and the RF upconverter further comprises a second summing device having a positive input terminal for receiving a second input signal, a negative input terminal coupled to said second output terminal of said electrical measurement circuit, and an output terminal coupled to said second input terminal of said upconverter core for providing said second signal.

7. The RF upconverter of claim 6 wherein said electrical measurement circuit further comprises:
a second mixer having a first input terminal for receiving said output signal, a second input terminal for receiving said quadrature local oscillator signal, and an output terminal; and
a second integrator having an input terminal coupled to said output terminal of said second mixer, and an output terminal for providing said second offset correction signal.

8. The RF upconverter of claim 7 wherein said electrical measurement circuit further comprises:
a second storage element having an input terminal coupled to said output terminal of said second integrator, and an output terminal; and
a second switch having a first terminal for providing said second output terminal of said electrical measurement circuit, and a second terminal alternately coupled to said output terminal of said second integrator during a calibrate period and to said output terminal of said second storage element during an operate period.

9. A method for carrier feedthrough cancellation in a radio frequency (RF) upconverter comprising:
converting a first signal having predetermined spectral content from an input frequency to a higher frequency using a local oscillator signal having a carrier frequency and providing an output signal having substantially said predetermined spectral content in response thereto;
electrically measuring a power of said output signal at said carrier frequency and providing a first offset correction signal in response thereto; and
subtracting said first offset correction signal from a first input signal to provide said first signal.

10. The method of claim 9 wherein electrically measuring said power comprises:
mixing said output signal with said local oscillator signal to provide a mixed signal; and
integrating said mixed signal to provide said first offset correction signal.

11. The method of claim 9 wherein converting said first signal from said input frequency to said higher frequency comprises converting said first signal from an intermediate frequency (IF) to RF.

12. The method of claim 9 wherein converting said first signal from said input frequency to said higher frequency comprises converting said first signal from baseband to RF.

13. The method of claim 12 wherein converting said first signal comprises:
converting said first signal from said input frequency to said higher frequency using said local oscillator signal to provide a first intermediate signal;
converting a second signal characterized as being in quadrature with said first signal from said input frequency to said higher frequency using a quadrature local oscillator signal having said carrier frequency to provide a second intermediate signal; and
summing said first and second intermediate signals to provide said output signal.

14. The method of claim 13 further comprising:
electrically measuring a power of said output signal at said carrier frequency using said quadrature local oscillator signal to provide a second offset correction signal; and
subtracting said second offset correction signal from a second input signal to provide said second signal.

15. A method for carrier feedthrough suppression in a radio frequency (RF) upconverter comprising:
converting first and second signals having predetermined spectral content from an input frequency to a higher frequency respectively using a local oscillator signal and a quadrature local oscillator signal each having a carrier frequency to provide an output signal having substantially said predetermined spectral content;
electrically measuring a power of said output signal using said local oscillator signal to provide a first offset correction signal; and
subtracting said first offset correction signal from an in-phase input signal to provide said first signal;
electrically measuring said power of said output signal using said quadrature local oscillator signal to provide a second offset correction signal; and
subtracting said second offset correction signal from a quadrature input signal to provide said second signal.

16. The method of claim 15 wherein converting said first and second signals comprises:
mixing said first signal with said local oscillator signal to provide a first intermediate signal;
mixing said second signal with said quadrature local oscillator signal to provide a second intermediate signal; and
summing said first and second intermediate signals to provide said output signal.

17. The method of claim 15 wherein electrically measuring said power of said output signal using said local oscillator signal comprises:
mixing said output signal with said local oscillator signal to provide a first mixed signal; and
integrating said first mixed signal to provide said first offset correction signal.

18. The method of claim 17 wherein electrically measuring said power of said output signal using said quadrature local oscillator signal comprises:
mixing said output signal with said quadrature local oscillator signal to provide a second mixed signal; and
integrating said second mixed signal to provide said second offset correction signal.

19. The method of claim 15 further comprising:
storing said first offset correction signal in a first storage element during a calibrate period; and
using an output of said first storage element as said first offset correction signal during an operate period.

20. The method of claim 19 further comprising:
storing said second offset correction signal in a second storage element during said calibrate period; and
using an output of said second storage element as said second offset correction signal during said operate period.
